(19) United States
(12) Patent Application Publication
(10) Pub. No.: US 2026/0179961 A1
(43) Pub. Date: Jun. 25, 2026

(54) DRY ELECTRODE MANUFACTURING METHOD AND SYSTEM

(71) Applicants: Hyundai Motor Company, Seoul (KR); Kia Corporation, Seoul (KR)

(72) Inventors: Han Nah SONG, Hwaseong-si (KR); Yong Il CHO, Hwaseong-si (KR); Young Soo LEE, Hwaseong-si (KR)

(21) Appl. No.: 19/247,908

(22) Filed: Jun. 24, 2025

(30) Foreign Application Priority Data
Dec. 20, 2024 (KR) 10-2024-0192068

(51) Int. Cl. H01M 4/62; B01F 23/60; B01F 29/64; B01J 19/08; C08J 3/20; C08J 3/28; C08J 5/18; H01M 4/04

(52) U.S. Cl. CPC H01M 4/628; B01F 23/60; B01F 29/64; B01J 19/08; C08J 3/203; C08J 3/28; C08J 5/18; H01M 4/0435; H01M 4/623; B01J 2219/0879; B01J 2219/0894; C08J 2327/18

(57) ABSTRACT

A dry electrode manufacturing method includes mixing one or more dry electrode materials and plasma-treating the one or more dry electrode materials. The one or more dry electrode materials include a dry electrode active material, a conductive material, and a binder, where the binder comprises polytetrafluoroethylene (PTFE). The method further includes forming a dry electrode film from a dry electrode mixture produced by mixing the one or more dry electrode materials.

### CROSS-REFERENCE TO RELATED APPLICATION

This application claims, under 35 U.S.C. § 119 (a), the benefit of priority from Korean Patent Application No. 10-2024-0192068, filed on Dec. 20, 2024, the entire contents of which are incorporated herein by reference.

### TECHNICAL FIELD

The present disclosure relates to manufacture of a dry electrode.

### BACKGROUND

Rechargeable secondary batteries may be applied to various fields from small electronic devices to large energy storage systems. For example, secondary batteries may be used for electric vehicles.

Electrodes of secondary batteries may be manufactured through a wet process. In the wet process, an electrode active material, a binder, and a conductive material included in an electrode are dissolved in a solvent to prepare a slurry. In some cases, a dry process without using the solvent may be used to increase the energy density of a battery.

In some cases, in the dry process of the electrode, manufacturing of the electrode may be completed by bonding the dry electrode film to a current collector.

Compared to the wet electrode manufacturing process, as the dry electrode manufacturing process does not use a solvent, the manufacturing time and costs may be reduced, and the film thickness may be controlled, thereby being capable of obtaining a dry electrode film having high energy density.

In some cases, in order to manufacture a free-standing dry electrode, complexation of the electrode active material and the conductive material and fibrillization of the binder in the mixing process are important.

In some cases, where a polytetrafluoroethylene (PTFE) binder is used as an anode, the electrode may have a low Lowest Unoccupied Molecular Orbital (LUMO) compared to a lithium reference electrode, which may lead to a reduction at around 0.4 to 0.6 volts (V). In some cases, this may cause a low initial efficiency when full cells are operated, thereby resulting in a large cell capacity loss. In some cases, alternative binders may mix PTFE with other binders, or coat PTFE with new materials.

### SUMMARY

The present disclosure describes a method of reducing a side reaction in an anode while utilizing PTFE, which is a binder advantageous for dry electrode manufacturing based on fibrillization characteristics thereof.

The present disclosure further describes a dry electrode manufacturing method and system using polytetrafluoroethylene (PTFE) as a binder.

The present disclosure further describes a dry electrode manufacturing method and system that can provide a simplified process using PTFE as a binder in a single process.

According to one aspect of the subject matter described in this application, a dry electrode manufacturing method includes mixing one or more dry electrode materials and plasma-treating the one or more dry electrode materials.

Implementations according to this aspect can include one or more of the following features. For example, mixing the one or more electrode materials can include mixing the one or more dry electrode materials under a predetermined mixing condition to produce a dry electrode mixture, where plasma-treating the one or more dry electrode materials can include plasma-treating the dry electrode mixture. The dry electrode manufacturing method can further include forming the plasma-treated dry electrode mixture into a dry electrode film.

In some examples, the one or more dry electrode materials can include a dry electrode active material, a conductive material, and a binder, where the binder can include polytetrafluoroethylene (PTFE).

In some implementations, the dry electrode manufacturing method can further include fibrillizing the binder through mixing the one or more dry electrode materials, where plasma-treating the one or more dry electrode materials can include plasma-treating the fibrillized binder.

In some examples, mixing the dry one or more electrode materials can include mixing the one or more dry electrode materials under a predetermined mixing condition to produce a dry electrode mixture, where the dry electrode manufacturing method can further include forming the dry electrode mixture into a dry electrode film, and plasma-treating the one or more dry electrode materials can include plasma-treating the dry electrode film.

In some implementations, plasma-treating the one or more dry electrode materials can include plasma-treating the one or more dry electrode materials while mixing the one or more dry electrode materials.

In some examples, mixing the dry one or more electrode materials can include mixing the one or more dry electrode material under a predetermined mixing condition to produce a dry electrode mixture, where the dry electrode manufacturing method can further include providing the dry electrode mixture to a roll press, and plasma-treating the one or more dry electrode materials can include plasma-treating the dry electrode mixture provided to the roll press.

According to another aspect, a dry electrode manufacturing method includes mixing one or more dry electrode materials in a mixer under a predetermined condition, supplying a process gas into the mixer, applying a predetermined voltage to the mixer, and operating the mixer.

Implementations according to this aspect can include one or more of the following features. For example, mixing the one or more dry electrode materials can include rotating the mixer at a first speed for a predetermined first time, and rotating the mixer at a second speed greater than the first speed for a predetermined second time. In some examples, operating the mixer can include rotating the mixer at a third speed less than the first speed for a predetermined third time.

In some examples, the dry electrode manufacturing method can further include stopping mixing the one or more dry electrode materials in the mixer before supplying the process gas. In some examples, operating the mixer can be performed simultaneously with applying the predetermined voltage to the mixer.

In some examples, the dry electrode manufacturing method can further include forming a dry electrode film from a dry electrode mixture that is produced by mixing the one or more dry electrode materials. In some examples, the one or more dry electrode materials comprise a binder comprising polytetrafluoroethylene (PTFE).

According to another aspect, a dry electrode manufacturing system includes a mixer configured to receive and mix one or more dry electrode materials, a film forming device configured to receive a dry electrode mixture that is produced by mixing the one or more dry electrode materials by the mixer, and a plasma treatment device configured to plasma-treat the dry electrode mixture in at least one of the mixer or the film forming device.

Implementations according to this aspect can include one or more of the following features. For example, the plasma treatment device can be disposed at and integrated with the mixer. In some implementations, the dry electrode manufacturing system can further include a feeder configured to provide the dry electrode mixture from the mixer to the film forming device, where the plasma treatment device is disposed at least one of (i) at the feeder, (ii) at the film forming device, or (iii) between the feeder and the film forming device. The plasma treatment device can be configured to plasma-treat the dry electrode mixture provided from the feeder to the film forming device.

In some examples, the plasma treatment device can include an atmospheric plasma treatment device. In some examples, the one or more dry electrode materials can include a binder comprising polytetrafluoroethylene (PTFE).

In some implementations, a battery can include a dry electrode manufactured by the dry electrode manufacturing methods described above.

### BRIEF DESCRIPTION OF THE DRAWINGS

The above and other features of the present disclosure will now be described in detail with reference to certain exemplary implementations thereof illustrated in the accompanying drawings which are given hereinbelow by way of illustration only, and thus are not limitative of the present disclosure.

FIG. 1 illustrates an example of a dry electrode manufacturing system.

FIG. 2 illustrates an example of changes in a chemical composition ratio of polytetrafluoroethylene (PTFE) by plasma treatment.

FIG. 3 illustrates an example structure of PTFE from which fluorine is removed by plasma treatment.

FIG. 4 is a flowchart illustrating an example of a dry electrode manufacturing method.

FIG. 5 is a view showing an example of a mixer including a plasma treatment portion of the dry electrode manufacturing system.

FIG. 6 is a flowchart illustrating an example of a dry electrode manufacturing method.

FIGS. 7A-7D illustrate examples of changes in a dry electrode material based on the process of FIG. 6.

FIG. 8 is a flowchart illustrating an example of a dry electrode manufacturing method.

FIG. 9 is a flowchart illustrating an example of a dry electrode manufacturing method.

FIG. 10 is a flowchart illustrating an example of a dry electrode manufacturing method.

FIG. 11 illustrates an example of a plasma treatment device of the dry electrode manufacturing system.

In the figures, reference numbers refer to the same or equivalent parts of the present disclosure throughout the several figures of the drawing.

### DETAILED DESCRIPTION

Specific structural or functional descriptions set forth in implementations of the present disclosure will be merely exemplarily given to describe the implementations depending on the concept of the present disclosure, and the implementations depending on the concept of the present disclosure can be embodied in different forms. Further, it will be understood that the present disclosure should not be construed as being limited to the implementations set forth herein, and the implementations of the present disclosure are provided only to completely disclose the disclosure and cover modifications, equivalents or alternatives which come within the scope and technical range of the disclosure.

Hereinafter, the present disclosure will be described in detail with reference to the accompanying drawings.

A dry electrode can be manufactured from a dry electrode mixture M and a current collector without a solvent. The dry electrode mixture M can be a mixture including an electrode active material, a conductive material (or a conductive additive or a conducting agent), and a binder. In addition, the dry electrode mixture M can further include an additive.

The dry electrode can be a cathode or an anode. In some implementations, when a cathode is manufactured, the electrode active material can include a cathode active material. As a non-limiting example, the cathode active material can include LCO (LiCoO₂), NCM (Li(Ni,Co,Mn)O₂), NCA (Li(Ni,Co,Al)O₂), LMO (LiMnO₄), LFP (LiFePO₄), or sulfur.

In some implementations, when an anode is manufactured, the electrode active material can include an anode active material. For example, the anode active material can include natural graphite, artificial graphite, mesocarbon microbeads (MCMB), or a silicon-based active material.

The conductive material can include a carbon-based conductive material. For example, the conductive material can include carbon black, acetylene black, carbon fibers, or carbon nanotubes.

The binder can include polyvinylidene fluoride (PVDF), polytetrafluoroethylene (PTFE), or a copolymer including the same.

As the additive, a solid polymer electrolyte, such as poly(ethylene oxide) (PEO), or some oxide-based or sulfide-based solid electrolyte components can be used.

The dry electrode material can include 70 wt % to 99.9 wt % of the electrode active material, 0.1 wt % to 20 wt % of the conductive material, and 0.1 wt % to 20 wt % of the binder. For instance, the additive can be added at a ratio of 0 to 20 wt %.

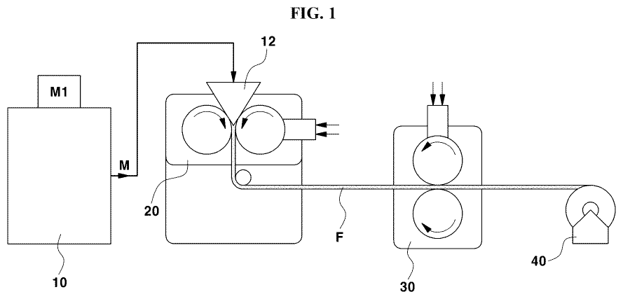

As shown in FIG. 1, in some implementations, a dry electrode manufacturing system can include a mixer. In some implementations, the mixer can include a mixer 10 or a mixer 100 (see FIG. 5). In some implementations, the system can include a plasma treatment system 200. In some examples, the system can include a roll press 20. In some examples, the system can further include a downstream roll press 30. In some examples, the system can further include a feeder 12. For instance, the feeder 12 can include a container with an inlet configured to receive the mixture M from the mixer 1 and an outlet configured to discharge the mixture M to the roll press 20. In some examples, the system can further include a winder 40.

A dry electrode mixture M is manufactured into a dry electrode film F through a series of film forming processes in which heat and pressure are applied. First, the dry electrode mixture including an electrode active material, a conductive material, and a binder is mixed by the mixer 10 at a predetermined speed for a predetermined time. As a non-limiting example, the dry electrode mixture M can be prepared by a high-shear mixer using rotation, a fluidized mixer using air, or the like, and the predetermined time and speed can be adjusted by changing the rotational speed and operating time of the mixer 10. In some examples, the mixer 10 can include a tank and a rotor.

The dry electrode mixture M mixed in the mixer 10 can be formed into the dry electrode film F by a film forming device. Specifically, the dry electrode mixture M mixed in the mixer 10 can be directed to the feeder 12 or the roll press 20. The dry electrode mixture M can be primarily pressed by the roll press 20 to be formed into the dry electrode film F. The roll press 20 rotates while providing pressing force to form the dry electrode mixture M into the dry electrode film F. The dry electrode film F that was primarily formed from the dry electrode mixture M can be additionally pressed by the downstream roll press 30, and the thickness of the dry electrode film F can be adjusted through pressing. Thereafter, the dry electrode film F is wound by the winder 40. Thereafter, the dry electrode film F can be bonded or laminated onto a current collector, thereby manufacturing a dry electrode.

In some examples, the dry electrode mixture M can refer to a powder in which the electrode active material, the conductive material, and the binder are appropriately mixed and dispersed by the mixer 10, and which is in a state of being formable into the dry electrode film F when pressed by the film forming device (e.g., roll press 20). In the following description, in order to distinguish a mixture in which the electrode active material, the conductive material, and the binder simply exist together from the above dry electrode mixture M, this mixture is referred to as a dry electrode material M1.

The dry electrode mixture M can be considered as being appropriately mixed and dispersed through fibrillization of the binder and complexation of the electrode active material and the conductive material. In other words, in order to manufacture a dry electrode in the form of a free-standing film, the complexation of the electrode active material and the conductive material plays an important role, along with the fibrillization of the binder. The complexation of the electrode active material and the conductive material can be explained as coating of the surface of the electrode active material with the conductive material. The coating of the electrode active material with the conductive material can be achieved by a high shear force applied by the mixer 10. The fibrillization of the binder can be explained as the binder being stretched thinly and long by the high shear force from the mixer 10 to connect the complexed electrode active material and conductive material into a network. The fibrillization of the binder can particularly allow the binder to serve as a structure so that the manufactured dry electrode can become a free-standing film.

In the manufacturing process of the dry electrode, the fibrillization of the binder and the complexation of the electrode active material and the conductive material can be achieved in the mixing process by the mixer 10. That is, the conductive material is complexed with the electrode active material by mixing the electrode active material and the conductive material. The network can be formed in the dry electrode mixture by adding the binder to the complexed particles to fibrillize the binder.

PTFE can be used as the binder of the dry electrode. However, PTFE can be electrochemically unstable when it is used to manufacture the dry electrode. Particularly, PTFE can be more electrochemically unstable when it is used in an anode. Specifically, when a battery is charged, the PTFE binder of the anode reacts with lithium (Li) ions, thereby causing a side reaction as described in Chemical Formula 1 below. Such a side reaction can reduce initial efficiency and cycle life and cause a decrease in cell capacity.

PTFE+Li→LiF+C [Chemical Formula 1]

Here, F is fluorine and C is carbon.

Accordingly, the present disclosure provides dry electrode manufacturing technology capable of reducing the electrochemical side reaction of PTFE.

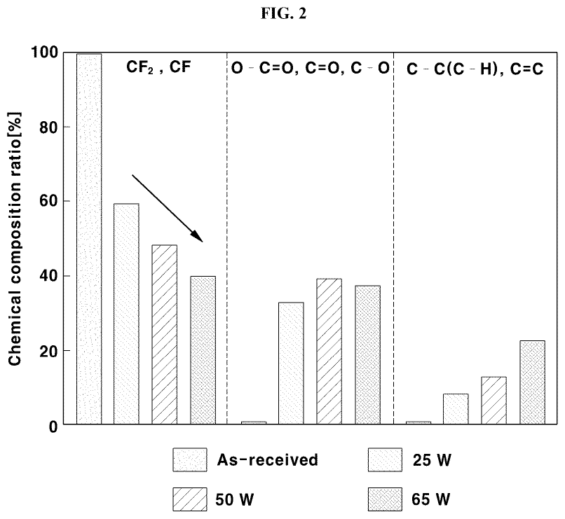

The dry electrode manufacturing system according to the present disclosure is configured to perform plasma treatment of the PTFE binder during fibrillization or the fibrillized PTFE binder. Referring to FIG. 2, the chemical composition ratio of PTFE was measured after plasma treatment of a PTFE sample. It was observed that the amount of fluorine tended to decrease as the plasma output increased. Based on this, it can be predicted that plasma treatment of the PTFE binder can reduce the possibility of forming LiF due to reduction in the amount of fluorine in PTFE and suppress the above side reaction.

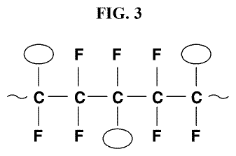

That is, the dry electrode manufacturing system according to the present disclosure can reduce the amount of fluorine in the PTFE binder using plasma (see FIG. 3). Ultimately, the present disclosure can reduce the possibility of forming LiF due to the reduced amount fluorine, thereby being capable of reducing the above side reaction.

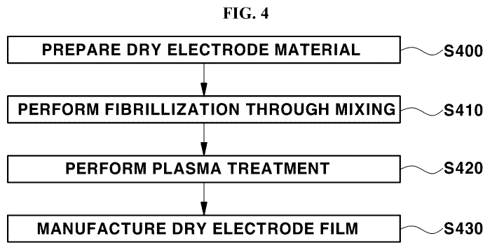

As shown in FIG. 4, in some implementations, the fibrillized PTFE binder can be plasma-treated in the mixing process. The mixing process can be performed in the mixer 100.

The dry electrode material M1 including the electrode active material, the conductive material, and the PTFE binder is prepared at operation S400). The prepared dry electrode material M1 is fed into the mixer 100. In some examples, the electrode active material, the conductive material, and the PTFE binder are fed into the mixer 100 in a predetermined order. In some examples, the electrode active material, the conductive material, and the PTFE binder can be fed into the mixer 100 simultaneously or at different times.

The operation of the mixer 100 is started so that the dry electrode material M1 is mixed. The fibrillization of the PTFE binder can be completed by operating the mixer 100 for a predetermined mixing time and/or under a predetermined mixing condition (e.g., the rotational speed of blades of the mixer 100, etc.) at S410. Once the fibrillization of the PTFE binder has been completed, the dry electrode mixture M can be obtained.

At Operation S420, the dry electrode mixture M is plasma-treated. That is, plasma treatment can be performed on the fibrillized PTFE binder.

At Operation S430, the plasma-treated dry electrode mixture M can be manufactured into a dry electrode film F. The plasma-treated dry electrode mixture M can be supplied to the roll press 20 through the feeder 12. The dry electrode mixture M can be formed into the dry electrode film F through the roll press 20, and the dry electrode film F can be manufactured into a dry electrode by being laminated onto a current collector.

As shown in FIG. 5, in some implementations, the mixer 100 can include a mixing portion and a plasma treatment portion. The mixer 100 including the mixing portion and the plasma treatment portion enables both mixing and plasma treatment in a single mixing process.

The mixing portion can include a rotatable housing 110 and a rotor 120. The rotor 120 can be rotatably supported by the housing 110. A shear force is applied by rotation of the rotor 120 so that the dry electrode material M1 in the housing 110 can be mixed to prepare the dry electrode mixture M. The rotor 120 is configured to receive driving force by a motor 130. In some examples, the rotational speed of the rotor 120 can be adjusted.

The plasma treatment portion can include a high voltage electrode 140 and a gas supply 150. The high voltage electrode 140 can be disposed in the housing 110. For example, the high voltage electrode 140 can be disposed in the housing 110 concentrically with the rotor 120. The high voltage electrode 140 is configured such that energy, such as electrical energy, is supplied thereto. The high voltage electrode 140 can be connected to an energy supply, such as a power source. The mixer 10 can be grounded by a ground electrode 160.

Process gas can be supplied into the housing 110. The gas supply 150 can be operably disposed in the housing 110 to supply the process gas into the housing 110.

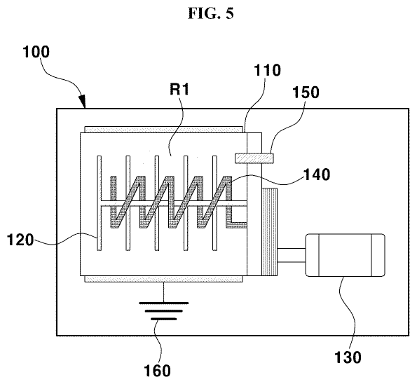

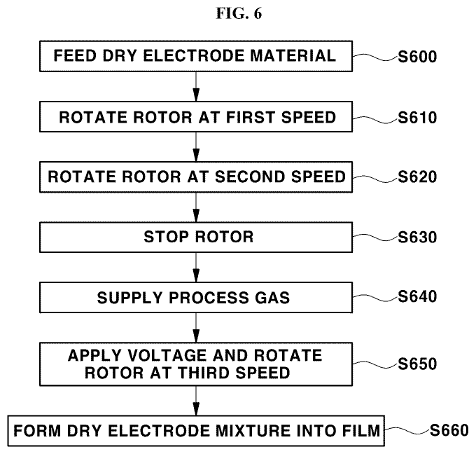

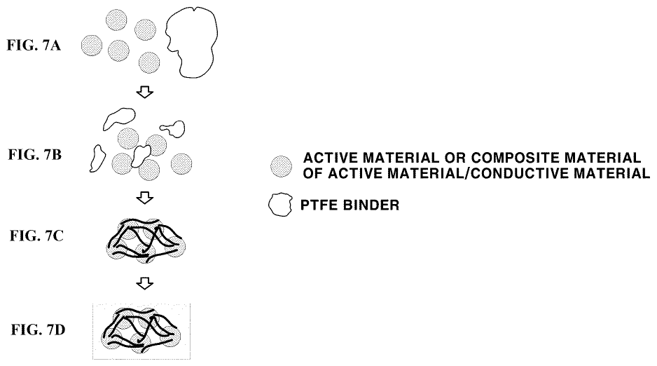

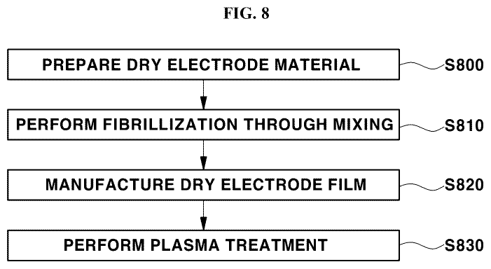

Referring to FIGS. 6 and 7, in some implementations, mixing of the dry electrode material M1 and plasma treatment of the fibrillized PTFE binder can be performed through operation of the mixer 100.

At Operation S600, the dry electrode material M1 including the electrode active material, the conductive material, and the PTFE binder is fed into the housing 110 of the mixer 100 in FIG. 7A. In some examples, the electrode active material, the conductive material, and the PTFE binder can be fed into the mixer 100 in a predetermined order. In some examples, the electrode active material, the conductive material, and the binder can be fed into the mixer 100 simultaneously or at different times.

At Operation S610, the operation of the mixer 100 is started. The rotor 120 is rotated at a first speed. The electrode active material or the composite material of the electrode active material and the conductive material can be gradually mixed by rotating the rotor 120 at the first speed for a predetermined first time as in FIG. 7B.

At Operation 620, the speed of the rotor 120 can be adjusted. The rotor 120 is configured to be rotated at a second speed higher than the first speed for a predetermined second time. Through the rotation of the rotor 120 at the second speed, a shear force is applied so that the PTFE binder can be fibrillized in FIG. 7C. The first time and the second time can be predetermined through experiments, etc. The dry electrode material M1 can be appropriately dispersed through the rotation of the rotor 120 at the first speed for the first time, and the fibrillization of the PTFE binder can be completed through the rotation of the rotor 120 at the second speed for the second time, so that the dry electrode M1 can be formed into the dry electrode mixture M.

After the rotor 120 is rotated for a predetermined time, the rotor 120 can be stopped at Operation S630. It can be considered that, at a point in time when the rotor 120 is stopped, the dry electrode M1 is formed into the dry electrode mixture M in FIG. 7D.

Thereafter, the dry electrode mixture M can be plasma-treated. At Operation S640, process gas can be supplied into the housing 110. The process gas can be supplied into the housing 110 through the gas supply 150 provided in the housing 110. As a non-limiting example, the process gas can include Ar, N₂, He, or O₂.

At Operation S650, energy can be supplied to the high voltage electrode 140, and plasma can be generated in a plasma generation region R1 within the housing 110. Therethrough, the fibrillized PTFE binder in the mixer 100 can be plasma-treated. In some examples, simultaneously, the rotor 120 can be rotated at a low speed. For example, the rotor 120 can be rotated at a third speed lower than or equal to the first speed. The dry electrode mixture M can be uniformly treated while being rotated at the low speed.

At Operation S660, a film forming process can be performed. The plasma-treated dry electrode mixture M can be supplied to the roll press 20 through the feeder 12, and the dry electrode mixture M can be formed into the dry electrode film F while passing through the roll press 20.

As shown in FIG. 8, in some implementations, after the film forming process has been completed, the dry electrode film F can be plasma-treated. In some examples, the dry electrode mixture M may not be plasma-treated in the mixer 100 during the mixing process, and after the dry electrode mixture M has been formed into the dry electrode film F, the dry electrode film F can be plasma-treated.

At Operation S800, the dry electrode material M1 including the electrode active material, the conductive material, and the PTFE binder is prepared. The prepared dry electrode material M1 is fed into the mixer 100. In some examples, the electrode active material, the conductive material, and the PTFE binder can be fed into the mixer 100 in a predetermined order. In some examples, the electrode active material, the conductive material, and the binder can be fed into the mixer 100 simultaneously or at different times.

The operation of the mixer 100 is started so that the dry electrode material M1 is mixed. The fibrillization of the PTFE binder is completed by operating the mixer 100 for a predetermined mixing time and/or under a predetermined mixing condition (e.g., the rotational speed of blades of the mixer 100, etc.) at Operation S810. Once the fibrillization of the PTFE binder has been completed, the dry electrode mixture M can be obtained.

At Operation S820, the dry electrode mixture M in which the fibrillization has been completed can be formed into the dry electrode film F through the film forming process by the roll press 20.

At Operation S830, the dry electrode film F can be plasma-treated. In a plasma treatment device, such as the mixer 100 including the plasma treatment portion, the dry electrode film F can be plasma-treated.

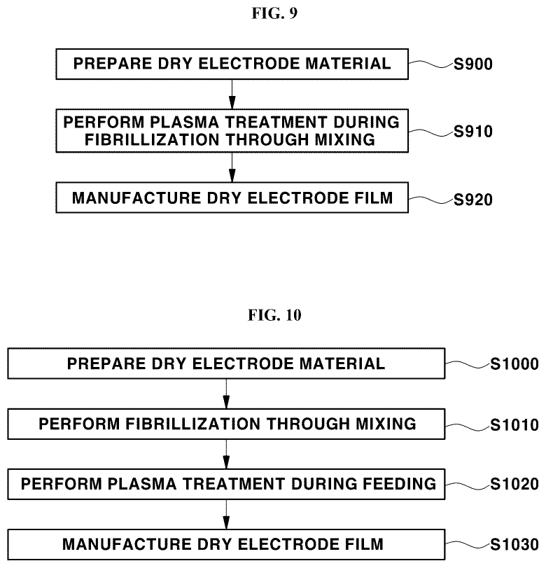

As shown in FIG. 9, in some implementations, the PTFE binder during fibrillization can be plasma-treated in the mixing process. The mixing process can be performed in the mixer 100.

The dry electrode material M1 including the electrode active material, the conductive material, and the PTFE binder is prepared at Operation S900. The prepared dry electrode material M1 is fed into the mixer 100. In some examples, the electrode active material, the conductive material, and the PTFE binder can be fed into the mixer 100 in a predetermined order. In some examples, the electrode active material, the conductive material, and the binder can be fed into the mixer 100 simultaneously or at different times.

The operation of the mixer 100 is started so that the dry electrode material M1 is mixed. The fibrillization of the PTFE binder is performed by operating the mixer 100 for a predetermined mixing time and/or under predetermined mixing conditions (e.g., the rotational speed of blades of the mixer 100, etc.) at Operation S910. In this implementation, the PTFE binder is plasma-treated through the plasma treatment portion of the mixer 100 before the fibrillization of the PTFE binder is completed during mixing.

If the fibrillization of the PTFE binder is completed under the predetermined mixing condition after the plasma treatment, the dry electrode mixture M can be obtained. At Operation S920, the plasma-treated dry electrode mixture M can be manufactured into the dry electrode film M. For example, the plasma-treated dry electrode mixture M can be supplied to the roll press 20 through the feeder 12. The dry electrode mixture M can be formed into the dry electrode film F through the roll press 20, and the dry electrode film F can be manufactured into a dry electrode by being laminated onto a current collector.

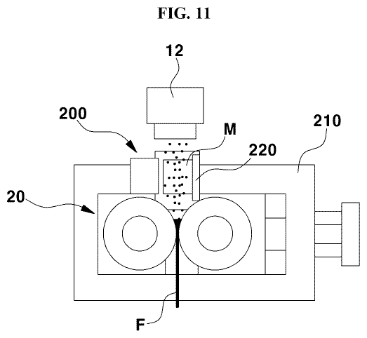

As shown in FIG. 10, in some implementations, after the mixing process has been completed, the fibrillized PTFE binder can be plasma-treated in the feeding process or the film forming process.

The dry electrode material M1 including the electrode active material, the conductive material, and the PTFE binder is prepared at Operation S1000. The prepared dry electrode material M1 is fed into the mixer 100. In some examples, the plasma treatment portion can be omitted from the mixer 100. In some examples, the electrode active material, the conductive material, and the PTFE binder can be fed into the mixer 100 in a predetermined order. In some examples, the electrode active material, the conductive material, and the binder can be fed into the mixer 100 simultaneously or at different times.

The operation of the mixer 100 is started so that the dry electrode material M1 is mixed. The fibrillization of the PTFE binder is performed by operating the mixer 100 for a predetermined mixing time and/or under predetermined mixing conditions (e.g., the rotational speed of blades of the mixer 100, etc.) at Operation S1010. Once the fibrillization of the PTFE binder has been completed, the dry electrode mixture M can be obtained.

The film forming process of the dry electrode mixture M can be performed. In one example, the dry electrode mixture M can be directed toward the feeder 12. The dry electrode mixture M can be supplied to the roll press 20 through the feeder 12. According to the present disclosure, plasma treatment can be performed on the dry electrode mixture M that is being supplied from the feeder 12 to the roll press 20 at Operation S1020.

The dry electrode mixture M that has been plasma-treated during feeding can be manufactured into the dry electrode film F by the roll press 20 at Operation S1030.

As shown in FIG. 11, in some implementations, the dry electrode manufacturing system can include a plasma treatment device or system 200. The plasma treatment device 200 is configured to plasma-treat the dry electrode mixture M supplied to the roll press 20 through the feeder 12. In some examples, the plasma treatment device 200 can be an atmospheric pressure plasma jet. For example, the plasma treatment device 200 can include an electric circuit configured to apply voltage to thereby ionize gas.

The plasma treatment device 200 can be disposed between the feeder 12 and the roll press 20. The plasma treatment device 200 can be supported by a frame 210 formed between the feeder 12 and the roll press 20. In some examples, the frame 210 can be a portion of the roll press 20. The plasma treatment device 200 can be grounded to the frame 210 through a ground electrode 220.

The PTFE binder can be fibrillized by physical mechanical shearing. Therethrough, the PTFE binder includes a feature that induces binding between particles, thus being capable of being used in a dry electrode. However, there can be a problem in which a cell capacity is reduced due to electrochemical reduction of PTFE at an anode.

Therefore, according to the present disclosure, the ratio of fluorine (F) on the surface of the fibrillized PTFE can be reduced through plasma treatment, thereby being capable of reducing the electrochemical side reaction elements of PTFE. Simultaneously, the present disclosure enables use of the characteristics of the binder that allows a dry electrode to be manufactured.

The present disclosure enables the side reaction to be suppressed through plasma treatment during the dry electrode manufacturing process without applying a heterogeneous binder system using PTFE and other binders together, thereby being capable of simplifying the process.

As is apparent from the above description, the present disclosure provides a dry electrode manufacturing method and system that can alleviate problems occurring when using polytetrafluoroethylene (PTFE) as a binder.

In addition, the present disclosure provides a dry electrode manufacturing method and system that can provide a simplified process by alleviating problems occurring when using PTFE as a binder in a single process.

The effects of the present disclosure are not limited to the above-mentioned effects, and other effects not mentioned herein will be clearly understood by those skilled in the art from the above description.

The present disclosure described above is not limited to the above-described exemplary implementations and the accompanying drawings, and it will be apparent to those skilled in the art to which the present disclosure pertains that various substitutions, modification, and changes are possible within a scope that does not depart from the technical spirit of the present disclosure.

What is claimed is:

1. A dry electrode manufacturing method comprising:
mixing one or more dry electrode materials; and
plasma-treating the one or more dry electrode materials.

2. The dry electrode manufacturing method of claim 1, wherein mixing the one or more electrode materials comprises mixing the one or more dry electrode materials under a predetermined mixing condition to produce a dry electrode mixture,
wherein plasma-treating the one or more dry electrode materials comprises plasma-treating the dry electrode mixture, and
wherein the dry electrode manufacturing method further comprises forming the plasma-treated dry electrode mixture into a dry electrode film.

3. The dry electrode manufacturing method of claim 1, wherein the one or more dry electrode materials comprise a dry electrode active material, a conductive material, and a binder, and
wherein the binder comprises polytetrafluoroethylene (PTFE).

4. The dry electrode manufacturing method of claim 3, further comprising:
fibrillizing the binder through mixing the one or more dry electrode materials,
wherein plasma-treating the one or more dry electrode materials comprises plasma-treating the fibrillized binder.

5. The dry electrode manufacturing method of claim 3, wherein mixing the dry one or more electrode materials comprises mixing the one or more dry electrode materials under a predetermined mixing condition to produce a dry electrode mixture,
wherein the dry electrode manufacturing method further comprises forming the dry electrode mixture into a dry electrode film, and
wherein plasma-treating the one or more dry electrode materials comprises plasma-treating the dry electrode film.

6. The dry electrode manufacturing method of claim 3, wherein plasma-treating the one or more dry electrode materials comprises plasma-treating the one or more dry electrode materials while mixing the one or more dry electrode materials.

7. The dry electrode manufacturing method of claim 3, wherein mixing the dry one or more electrode materials comprises mixing the one or more dry electrode material under a predetermined mixing condition to produce a dry electrode mixture,
wherein the dry electrode manufacturing method further comprises providing the dry electrode mixture to a roll press, and
wherein plasma-treating the one or more dry electrode materials comprises plasma-treating the dry electrode mixture provided to the roll press.

8. A dry electrode manufacturing method comprising:
mixing one or more dry electrode materials in a mixer under a predetermined condition;
supplying a process gas into the mixer;
applying a predetermined voltage to the mixer; and
operating the mixer.

9. The dry electrode manufacturing method of claim 8, wherein mixing the one or more dry electrode materials comprises:
rotating the mixer at a first speed for a predetermined first time; and
rotating the mixer at a second speed greater than the first speed for a predetermined second time.

10. The dry electrode manufacturing method of claim 9, wherein operating the mixer comprises rotating the mixer at a third speed less than the first speed for a predetermined third time.

11. The dry electrode manufacturing method of claim 8, further comprising stopping mixing the one or more dry electrode materials in the mixer before supplying the process gas.

12. The dry electrode manufacturing method of claim 8, wherein operating the mixer is performed simultaneously with applying the predetermined voltage to the mixer.

13. The dry electrode manufacturing method of claim 8, further comprising forming a dry electrode film from a dry electrode mixture that is produced by mixing the one or more dry electrode materials.

14. The dry electrode manufacturing method of claim 8, wherein the one or more dry electrode materials comprise a binder comprising polytetrafluoroethylene (PTFE).

15. A dry electrode manufacturing system comprising:
a mixer configured to receive and mix one or more dry electrode materials;
a film forming device configured to receive a dry electrode mixture that is produced by mixing the one or more dry electrode materials by the mixer; and
a plasma treatment device configured to plasma-treat the dry electrode mixture in at least one of the mixer or the film forming device.

16. The dry electrode manufacturing system of claim 15, wherein the plasma treatment device is disposed at and integrated with the mixer.

17. The dry electrode manufacturing system of claim 15, further comprising a feeder configured to provide the dry electrode mixture from the mixer to the film forming device,
wherein the plasma treatment device is disposed at least one of (i) at the feeder, (ii) at the film forming device, or (iii) between the feeder and the film forming device, and
wherein the plasma treatment device is configured to plasma-treat the dry electrode mixture provided from the feeder to the film forming device.

18. The dry electrode manufacturing system of claim 17, wherein the plasma treatment device comprises an atmospheric plasma treatment device.

19. The dry electrode manufacturing system of claim 15, wherein the one or more dry electrode materials comprises a binder comprising polytetrafluoroethylene (PTFE).

20. A battery comprising a dry electrode manufactured by the dry electrode manufacturing method of claim 1.
